(19) United States
(12) Patent Application Publication
(10) Pub. No.: US 2023/0240370 A1
(43) Pub. Date: Aug. 3, 2023

(54) Evaporator Assembly

(71) Applicant: JT International SA, Geneva (CH)

(72) Inventors: Alec Wright, Guildford (GB); Andrew Robert John Rogan, Forres (GB); Kyle Adair, Lisburn (GB); Olayiwola Olamiposi Popoola, Walton-on-Thames (GB); Gordon Montgomery, Ballymena (GB)

(73) Assignee: JT International SA, Geneva (CH)

(21) Appl. No.: 18/007,205

(22) PCT Filed: Jul. 21, 2021
(86) PCT No.: PCT/EP2021/070338

§ 371 Date: Jan. 27, 2023

(30) Foreign Application Priority Data
Jul. 29, 2020 (EP) 20188450.9

(51) Int. Cl. A24F 40/485; A24F 40/10; A24F 40/46; A24F 40/42; F16K 99/00; F16K 37/00; H05B 3/22

(52) U.S. Cl. CPC A24F 40/485; A24F 40/10; A24F 40/46; A24F 40/42; F16K 99/0011; F16K 99/0044; F16K 37/0041; H05B 3/22; H05B 2203/021

(57) ABSTRACT

An evaporator assembly for an aerosol generating device is described. The evaporator assembly comprises a first body having a first plurality of through-channels, a second body having a second plurality of through-channels, wherein the first body and the second body are arranged such that the first and second plurality of through-channels overlap to allow the passage of a liquid from an inlet end to an outlet end of the evaporator assembly through the through-channels; and a heater arranged to heat the liquid as it passes through the through-channels, wherein the second body is moveable with respect to the first body such that the area of overlap is adjustable.

### FIELD OF INVENTION

The present invention relates to aerosol generating devices, and more specifically evaporator assemblies for aerosol generating devices.

### BACKGROUND

Aerosol generating devices, such as electronic cigarettes, are becoming increasingly popular consumer products.

Some aerosol generating devices generate a vapour or aerosol from a vaporisable liquid. Different vaporisable liquids can have different properties (for example viscosity, density and volatility), which may be the result of the presence of different colourants, flavourings and other chemical components in the liquid. These different properties can affect the behaviour of the liquid under the conditions to which it is subjected in the vapour generation process, and this can affect the quality of the generated vapour, for example the size of the liquid droplets in the vapour, the temperature of the vapour and the overall rate at which the vapour is generated. To ensure an optimal user experience, it is desirable that the quality of the vapour generated by a vapour generating device is consistent between vaporisable liquids with different compositions and under different ambient conditions. There is thus a demand for vapour generating devices that enable a greater degree of control over the characteristics of the generated vapour than is achieved by current devices.

### SUMMARY

A first aspect of the invention provides an evaporator assembly for an aerosol generating device comprising a first body having a first plurality of through-channels, a second body having a second plurality of through-channels, wherein the first body and the second body are arranged such that the first and second plurality of through-channels overlap to allow the passage of a liquid from an inlet end to an outlet end of the evaporator assembly through the through-channels and a heater arranged to heat the liquid as it passes through the through-channels, wherein the second body is moveable with respect to the first body such that the area of overlap is adjustable.

Using this arrangement, the liquid flow through the evaporator may be adjusted by changing the degree of overlap between the first and second plurality of through-channels. Therefore the amount of liquid flowing through the evaporator, and accordingly the amount of liquid being evaporated within the channels, may be adjusted. A user may therefore control the amount of vapour produced by the evaporator, improving the user experience. Furthermore, the invention allows for the evaporator to be configurable for use with liquids with different properties, in particular viscosity. The rate at which a liquid flows through a channel depends on the viscosity of the liquid and the dimensions of the channel. By moving the first body relative to the second body to adjust the degree of overlap between the first plurality of through-channels and second plurality of through-channels, the cross-sectional area at the interface between the first body and second body may be changed to configure the channel dimensions for a particular liquid viscosity.

Preferably the heater is arranged to heat the liquid such that it evaporates as it passes through the through-channels. Preferably one or both of the first and second bodies may be heatable so as to heat the liquid passing through the through-channels. Heating the capillary channels directly to evaporate the liquid provides a particularly efficient mechanism of both transporting and evaporating the liquid, which can be more closely controlled relative to conventional devices which use a wick or other form of liquid transfer element to transport liquid to a heating chamber where it is then evaporated. In particular, in the present invention the fact that the heater is arranged to heat the liquid as it passes through the through-channels means the liquid is heated while it is transported from the liquid reservoir, providing improvements in terms of efficiency and the size of the components required relative to conventional devices where the liquid is first transported and then subsequently heated.

The first and/or second bodies may comprise a heat conductive material and an external heater may be provided to heat one of both of the first and second bodies to achieve this. Alternatively, one or both of the first and second bodies may comprise the heater themselves—i.e. they may act as the heater by hearing the liquid as it passes within the through-channels. In a particularly preferable arrangement one or both of the first and second bodies are heatable by resistive heating. That is, one or both of the first and second bodies may comprise an electrically conductive material configured such that one or both of the first and second bodies may be heated by passing a current through one or both of the first and second bodies. For example, one or both of the first and second bodies may comprise a metal, a semiconductor, such as silicon, or a ceramic. In the case of the semiconductor and ceramic, the material may be doped to tune the resistivity and therefore the resistive heating performance.

Preferably the first body comprises an inlet surface and an outlet surface (also referred to as a contact surface) and the first plurality of through-channels run through the first body from the inlet surface to the outlet surface. Preferably the second body comprises an inlet surface (also referred to as a contact surface) and an outlet surface and the second plurality of through-channels run through the second body from the inlet surface to the outlet surface. Preferably the first body outlet surface is in contact with the second body inlet surface, i.e. the contact surfaces are in contact. Preferably the contact surfaces are parallel. Preferably the first and/or second body are moveable by translation in a plane corresponding to the contact surfaces. Preferably the first and/or second body are rotatable about an axis perpendicular to the contact surfaces. Preferably movement of the first body relative to the second body changes the degree of registration of the respective openings of the first plurality of through-channels and second plurality of through-channels on the contact surfaces.

Preferably the first body and/or second body comprise a plate. In particular they may each comprise a flat surface wherein the flat surfaces are in contact to provide fluid connection between the respective plurality of through-channels.

In a preferred embodiment the first and second bodies are arranged parallel to each other. In particularly preferred embodiments, the second body is disposed directly on the first body such that the second plurality of through-channels are in fluid communication with the first plurality of through-channels. The area of overlap of the first plurality of through-channels with the second plurality of through-channels can be adjusted by moving the second body with respect to the first body. This allows the through-channels to open, either fully or partially, and close, which influences the rate at which a vaporisable liquid travels along the through-channel (in particular when this transport is driven by capillary action). More specifically, the first plurality of channels preferably have a corresponding first plurality of openings on the first body and the second plurality of channels have a corresponding second plurality of openings on the second body. Preferably the evaporator is configured such that movement of the first body relative to the second body changes the amount of overlap between the first plurality of openings and second plurality of openings to change the rate at which liquid flows through the evaporator.

Accordingly, adjusting the degree of overlap of the through-channels can affect the rate at which the vaporisable liquid is transported to the outlet end of the evaporator assembly and the size of the droplets that are produced there. The second body can therefore be moved in such a manner as to ensure consistency of particular characteristics of the generated vapour such as droplet size and flow rate.

The second body can be moved with respect to the first body in any suitable manner. For example, the second body can be translated laterally with respect to the first body. The second body may also be rotated with respect to the first body. The first body and/or second body may comprise a shape memory alloy to control the movement of the second body with respect to the first body. In this embodiment, when the first and/or second body is heated, the heat passes to the shape memory alloy causing it to deform thus moving the first and/or second body with respect to one another. This allows for feedback of the system to change the alignment of the first plurality of through-channels with the second plurality of through-channels depending upon the temperature of the shape memory alloy. This can change the rate at which the vaporisable liquid is transported to the outlet end of the evaporator assembly and the size of the droplets that are produced there. For example, if the temperature increases, the shape memory allow may change shape to reduce the overlap between the first and second plurality of through channels, thus compensating for an increase in viscosity of the liquid. The first body and/or second body may be spring loaded in order to control the movement of the second body with respect to the first body. The spring may comprise a shape memory alloy such that the spring changes shape depending on the temperature to move the second body relative to the first body. The second body may be coupled to a stepper motor, and optionally, further comprise a rotary encoder to control the movement of the second body with respect to the first body. The evaporator assembly may further comprise a strain gauge for measuring the relative displacement of the first body relative to the second body. In particular, the strain gauge may be configured to measure relative movement of the first and second body, for example by measuring a strain applied to the strain gauge by the first and/or second body.

In this way the strain gauge may be used to provide feedback on the relative position of the first and second body in order to control the movement. The strain gauge may also be used to determine a type of cartridge received by the evaporator assembly. For example, a cartridge, which may preferably include a liquid reservoir, may have a shape so as to exert a force on the first and/or second body to move it into a required position when the cartridge is inserted into the device. By providing cartridges with different shapes, and therefore which move the first and/or second body to different positions, the strain gauge may be configured to determine the type of cartridge inserted by the measured strain.

In preferred embodiments, the first and second plurality of through-channels are arranged in a regular array. This helps to achieve a uniform rate of liquid transport across the extent of the bodies and leads to efficient adjustment of the overlap of the through-channels. However, in other embodiments, the arrangement of the first plurality of channels may be non-regular.

The first and second bodies may be any structure, or assembly of structures, that provide a plurality of through-channels suitable for transporting the vaporisable liquid, so long as the second body is moveable in the manner defined above. In some embodiments the second body may conveniently be provided as an integral structure shaped to define the second plurality of channels, though this is not essential. In some preferred embodiments, the outlet end of the evaporator assembly is a surface of the second body.

Preferably each of the first and second plurality of through-channels is adapted to transport the liquid through the first and second bodies respectively by capillary action. The ability of the through-channels to transport the liquid by capillary action may depend on the contact angle between the liquid and the material from which the first and second bodies are made (which may itself depend on the local temperature and pressure) and the dimensions of the through-channels. In other embodiments, the liquid may be transported through the first and second plurality of through-channels by other means, for example by gravity or by the application of pressure.

In preferred embodiments, the evaporator assembly comprises a first heater arranged to heat the second body. Heating the second body can affect the contact angle between the liquid and the material of the body, and this in turn influences the rate at which the liquid is drawn through the second plate by capillary action (if the second plurality of channels are adapted to transport the liquid by capillary action). Heating the second body can also affect the properties of the vapour generated by the evaporator assembly. In particularly preferred embodiments, the first heater comprises an electrical source configured to generate a current through the second body so as to cause resistive heating of the second body. However, the first heater could alternatively be configured to deliver heat to the second body from a separate heat source. The evaporator assembly may further comprise a second heater arranged to heat the first body. This provides additional control over the rate of transport of the liquid through the first body (and hence through the evaporator assembly as a whole) as explained above with reference to the first heater. The heater is preferably configured to heat the liquid so that the liquid evaporates as it passes through the through-channels. In particular, the heater is preferably provided by one or both of the evaporator bodies, wherein the evaporator comprises circuitry for passing a current through the first and/or second body to heat the evaporator bodies by resistive heating to evaporate the liquid as it passes through the first and/or second plurality of through channels.

According to a second aspect of the invention, there is provided an aerosol generating device comprising the evaporator assembly according to the first aspect of the invention, a power source arranged to supply power to the evaporator assembly and a reservoir for storing the liquid, wherein the reservoir is fluidically coupled to the first body.

The aerosol generating device of the second aspect of the invention may have any of the features described as preferred or optional with regard to the evaporator assembly of the first aspect of the invention. Optionally, the reservoir is removable from the aerosol generating device. In particular, the reservoir may be provided as a removable capsule configured to be received by the aerosol generating device. The capsule preferably connects with the aerosol generating device such that the reservoir is in fluidic communication with the evaporator assembly. Preferably the aerosol generating device and capsule may be configured such that the connection between the capsule and aerosol generating device moves the first and/or second body to provide a predetermined amount of overlap between the first plurality of through-channels and the second plurality of through-channels. In particular, the capsule may be shaped such that, when the capsule is received within the aerosol generating device, it applies a force to the first or second body to provide the required relative orientation. In this way, the capsule can be configured such that a required degree of overlap between the first plurality of through-channels and the second plurality of through-channels is automatically set upon receiving the cartridge in the aerosol generating device. For example, for a capsule comprising a reservoir holding liquid of higher viscosity, the capsule may be configured to move the first body relative to the second body so as to provide a greater overlap between the first plurality of through-channels and the second plurality of through-channels to provide a greater cross-sectional area for the flow of the more viscous fluid.

Preferably, the aerosol generating device comprises a porous wick. The wick may form part of the, evaporator assembly, aerosol generating device or the capsule. The porous wick is preferably arranged to draw liquid from the reservoir to the inlet end of the evaporator by capillary action.

According to a third aspect of the invention, there is provided an aerosol generating device comprising a housing, a device evaporator body within the housing and a heater, wherein the device evaporator body has a second plurality of through-channels, wherein the housing is configured to receive a consumable capsule comprising a reservoir for storing a liquid and a capsule evaporator body having a first plurality of through-channels, such that the first plurality of through-channels and the second plurality of through-channels overlap to allow the passage of a liquid through the first and second through-channels and wherein the device evaporator body is moveable relative to the consumable capsule when received in the housing such that the area of overlap between the first plurality of through-channels and second plurality of through channels is adjustable.

In this way, the second body, also referred to as a capsule evaporator body, forms part of a removable cartridge. The same advantages above may be achieved by third aspect of the invention. Preferably the aerosol generating device may comprise a movement mechanism for moving the capsule evaporator body relative to the device evaporator body to change the area of overlap between the first and second plurality of through-channels. The optional features described above with respect to the first and second aspects, and those defined in the appended claims, may equally be applied to the aerosol generating device of the third aspect.

### BRIEF DESCRIPTION OF DRAWINGS

Embodiments of the invention are now described, by way of example, with reference to the drawings, in which:

FIG. 1 is a conceptual cross-sectional view of an evaporator assembly 101 for an aerosol generating device;

FIG. 2 is a conceptual plan view of a first body 109 and a second body 111 suitable for use in embodiments of the invention;

FIG. 3 is a conceptual cross-sectional view of an evaporator assembly 101 integrated into a portion of an aerosol generating device 301 in accordance with the second aspect of the invention; and

FIG. 4 is a schematic of an embodiment of an aerosol generating device 401 in accordance with the third aspect of the invention.

FIG. 5 is a schematic of an embodiment of an aerosol generating device 501 in accordance with the third aspect of the invention.

### DETAILED DESCRIPTION

An aerosol generating device is a device arranged to heat an aerosol generating product to produce an aerosol for inhalation by a consumer. In a specific example, an aerosol generating product can be a liquid which forms an aerosol when heated by the aerosol generating device. An aerosol generating device can also be referred to as an electronic cigarette or vapour generating device. In the context of the present disclosure, the terms vapour and aerosol can be used interchangeably. An aerosol generating product, or vapour generating product, can be a liquid or a solid such as a fibrous material, or a combination thereof, that when heated generates a vapour or aerosol.

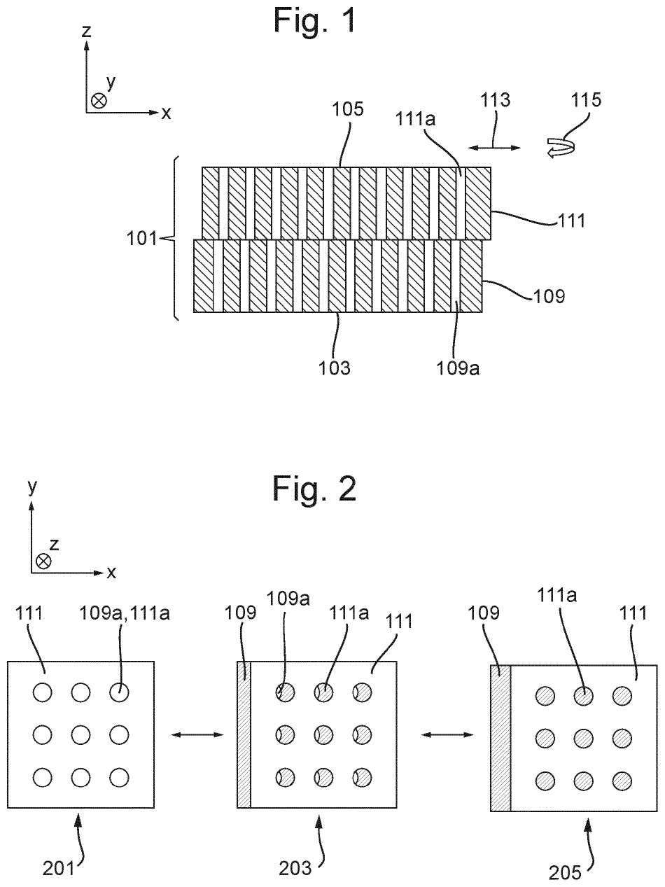

FIG. 1 shows a cross-sectional diagram of an evaporator assembly 101 for an aerosol generating device. The evaporator assembly 101 comprises a first body 109 and a second body 111, arranged to vaporise a liquid received from an inlet end 103 of the evaporator assembly 101 and allow passage of the vaporised liquid to an outlet end 105 of the evaporator assembly 101.

The first body 109 has a first plurality of through-channels 109a that extend through the first body 109 and a second plurality of through-channels 111a extend through the second body 111.

The first body 109 is configured to receive a vaporisable liquid from an inlet end 103. The first plurality of through-channels 109a extend parallel to one another along the z direction. In this example, the first plurality of through-channels 109a are regularly spaced from one another along the x direction. Each one of the first plurality of through-channels 109a is sufficiently narrow (i.e. has a sufficiently small cross-sectional area in the x-y plane) that when it receives the vaporisable liquid, the vaporisable liquid can travel along the first plurality of through-channels 109a by capillary action.

The second body 111 is disposed directly on the first body 109. The second plurality of through-channels 111a extend along the z direction, parallel to one another, through the second body 111. In use, the second plurality of through-channels 111a overlap with the first plurality of through-channels 109a to receive a vaporisable liquid from the first plurality of through-channels 109a when the vaporisable liquid is transported through the first body 109 by capillary action as described above. The second plurality of through-channels 111a transport the vaporisable liquid by capillary action to an outlet end 105 of the evaporator assembly 101, which is a surface of the second body 111.

The second body 111 is moveable with respect to the first body 109. This allows the degree of overlap of the first plurality of through-channels 109a and the second plurality of through-channels 111a to be adjusted and therefore the through-channels can be open, partially open, or closed. More specifically, the first plurality of through-channels 109a preferably have a corresponding first plurality of openings on the first body 109 and the second plurality of channels 111a have a corresponding second plurality of openings on the second body 111. Preferably the evaporator assembly 101 is configured such that movement of the first body 109 relative to the second body 111 changes the amount of overlap between the first plurality of openings and second plurality of openings to change the rate at which liquid flows through the evaporator. For example, the second body 111 can be continually advanced and retracted along the x direction as indicated by the arrow 113, or rotated around the z axis as indicated by the arrow 115, such that the degree of overlap of the first plurality of through-channels 109a with the second plurality of through-channels 111a is adjusted. Changing the degree of overlap of the first plurality of through-channels 109a with the second plurality of through-channels 111a affects the rate at which the vaporisable liquid travels through the through-channels by capillary action. Accordingly, adjustably moving the second body 111 with respect to the first body 109 can be used to vary the rate at which the vaporisable liquid is transported to the outlet end 105 of the evaporator assembly 101. This in turn can affect the size of the droplets in the generated vapour and the overall rate at which the vapour is produced.

The first body 109 and/or second body 111 may further comprise a spring mechanism (not shown) to control the movement of the second body 111 with respect to the first body 109. In some examples the spring may comprise a shape memory alloy material arranged to change shape when the temperature reaches a predetermined threshold temperature. In this way, the relative alignment of the first 109 and second 111 body, and therefore the amount of liquid flow through the evaporator, is also determined by the temperature provided by the heater. Alternatively, the second body 111 may be coupled to a stepper motor (not shown), and optionally, further comprise a rotary encoder (not shown) to measure the movement of the second body 111 with respect to the first body 109.

The evaporator assembly 101 may further comprise a strain gauge (not shown) for measuring the relative displacement of the first body 109 relative to the second body 111. In particular, the strain gauge may be configured to measure relative movement of the first body 109 and second body 111, for example by measuring a strain applied to the strain gauge by the first body 109 and/or second body 111. In this way the strain gauge may be used to provide feedback on the relative position of the first body 109 and second body 111 in order to control the movement. The strain gauge may also be used to determine a type of cartridge received by the evaporator assembly 101.

A heater is arranged to supply heat to the liquid as it passes through an inlet end 103 to an outlet end 105 of the evaporator assembly 101. In this example, a first heater is provided within the first body 109 and a second heater is provided in the second body 111. More particularly, the first and/or second body comprise an electrically conductive material and a current is passed through the first and second bodies to heat them using resistive heating. Suitable materials for forming the first body 109 and second body 111 are for example silicon and germanium, ceramics, metals and metalloids. Silicon-based materials are generally preferred, however. Ceramic materials and semiconductor materials, such as silicon, may be doped with a selected dopant concentration which can influence resistivity and therefore the heating of the materials due to resistive heating when a current is passed through.

For example, the second body 111 may be connected to a first control circuit (not shown). The first control circuit is configured to apply a voltage across the second body 111, which can be controlled by the first control circuit so as to heat the second body 111 by resistive heating. The voltage applied by the first control circuit can also be controlled so as to influence parameters such as the contact angle between the vapourisable liquid and the interior of the second plurality of through-channels 111a, which in turn affect the rate at which the liquid is transported to the outlet end 105 and the properties of the generated vapour. For example, when the second body 111 is heated, the temperature of the liquid inside the second plurality of through-channels 111a increases. This typically increases the rate at which the vapour is generated.

Similarly, the first body 109 may be connected to a second control circuit (not shown). Like the first control circuit, the second control circuit is configured to vary the voltage across the first body 109 so as to control the temperature of the first body 109 and parameters such as the contact angle between the vapourisable liquid and the first plurality of through-channels 109a. It is preferable that the second body 111 is kept at a higher temperature than the first body 109 when the first body 109 and/or second body 111 is heated. Hence, in this embodiment, each of the first body 109 and the second body 111 is a micro-electromechanical system (MEMS) that affords control over the rate at which the vapourisable liquid is transported to the outlet end 105 of the evaporator assembly 101 and the properties of the generated vapour.

Although in this embodiment each of the first body 109 and second body 111 is provided with a separate control circuit, a single control circuit could be configured to control both bodies in other embodiments.

In an alternative embodiment, an external first heater (not shown) may be arranged to supply heat to the first body 109. The external first heater can be electrically powered (for example by a battery of a vapour generating device in which the evaporator assembly 101 is contained) and controlled by an electronic controller. When the first body 109 is heated, the temperature of the liquid inside the first plurality of through-channels 109a increases. This typically increases the rate at which the vapour is generated. Similarly, the second body 111 may be provided with a second external heater (not shown), which may also be electrically powered and controlled by an electronic controller.

In this embodiment each of the first body 109 and the second body 111 are provided with a respective external heater, though this is not essential. For example, the second external heater could be omitted such that only the first body 109 is provided with an external heater. In other embodiments, both the first body 109 and second body 111 could be heated by a single external heater.

In embodiments where the second body 111 is heated (whether the first body 109 is heated or otherwise), it is preferable that the second body 111 is kept at a higher temperature than the first body 109 when the evaporator assembly 101 is in use. In this embodiment, the external heaters are external to the first body 109 and second body 111 and the heaters are configured to heat the bodies by conductive heating. The first and second bodies 109, 111 comprise a heat conductive material such as metal or a ceramic such that the heat provided by the external heaters is passed through the evaporator bodies 109, 111.

Although the first and second bodies 109, 111 may be heated by external heaters, it is preferred that the first and second bodies 109, 111 comprise an electrically conductive material and a current is passed through the first and second bodies to instead heat them using resistive heating.

FIG. 2 shows the adjustable movement of a second body 111 comprising a second plurality of through-channels 111a with respect to a first body 109 comprising a first plurality of through-channels 109a in the x direction, suitable for use in the first aspect of the invention. In this embodiment, the second body is translated laterally with respect to the first body. More specifically, the first plurality of through-channels 109a preferably have a corresponding first plurality of openings on the first body 109 and the second plurality of channels 111a have a corresponding second plurality of openings on the second body 111. Preferably, movement of the first body 109 relative to the second body 111 changes the amount of overlap between the first plurality of openings and second plurality of openings to change the rate at which liquid flows through the evaporator.

The first arrangement 201 shows the second body 111 disposed on top of a first body 109 such that the first plurality of through-channels 109a of the first body 109 are fully aligned with the second plurality of through-channels 111a of the second body 111. In this arrangement the through-channels are fully open which allows for the greatest amount of vaporisable liquid to be transported through the through-channels 109a and 111a.

The second arrangement 203 shows the overlap of the first plurality of through-channels 109a of the first body 109 with the second plurality of through-channels 111a of the second body 111, when the second body 111 has been translated in the x direction with respect to the first body 109. In the second arrangement 203, the first plurality of through-channels 109a are only partially aligned with the second plurality of through-channels 111a. In this arrangement, the through-channels are only partially open leading to a reduced amount of vaporisable liquid to be transported through the through-channels 109a and 111a when compared with the first arrangement 111a.

The third arrangement 205 shows no overlap of the first plurality of through-channels 109a of the first body 109 with the second plurality of through-channels 111a of the second body 111, when the second body 111 has been translated in the x direction with respect to the first body 109. This arrangement does not allow for any alignment of the first plurality of through-channels 109a with the second plurality of through-channels 111a. In this arrangement the through-channels are closed and therefore the vaporisable liquid cannot pass to the second plurality of through-channels 111a from the first plurality of through-channels 109a.

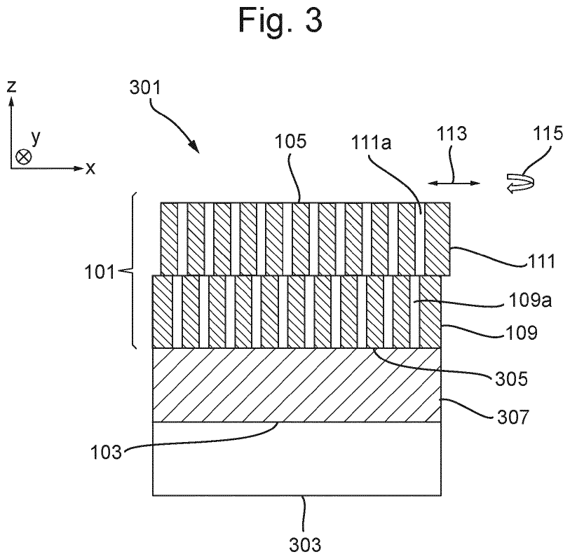

FIG. 3 shows an evaporator assembly 101 in accordance with the first aspect of the invention integrated into a portion of an aerosol generating device 301. The aerosol generating device 301 comprises an evaporator assembly 101 as described with respect to FIG. 1. In this embodiment, the evaporator assembly 101 further comprises an optional porous wick 307, which is in contact with the first body 109 of the evaporator assembly 101. The inlet end 103 of the evaporator assembly 101 is a surface of the porous wick 307, which is made of a porous material suitable for absorbing the vapourisable liquid in the reservoir. The surface of the porous wick 307 is in contact with a reservoir 303 of a vapourisable liquid. The reservoir 303 could be part of an aerosol generating device in accordance with the third aspect of the invention.

The first plurality of through-channels 109a are arranged to draw liquid from the reservoir 303 to the second plurality of through-channels 111a by capillary force. In this embodiment, the porous wick 307 can aid in the transfer of liquid from the reservoir 303 to the first plurality of through-channels 109a of the first body 109. The inclusion of a porous wick 307 is optional. In this way, the reservoir 303 can either be in direct connection with the first body 109, or in indirect connection with the first body 109 by way of the porous wick 307. If the porous wick 307 is not present, a surface of the first body 305 acts as an inlet end 103 of the evaporator assembly 101.

In operation, liquid is drawn from the reservoir 303 into the first plurality of through-channels 109a of the first body 109. The liquid then travels into and through the first plurality of through-channels 109a to the second plurality of through-channels 111a by capillary action. A power source (not shown) is used to apply a potential to the evaporator assembly 101 so as to heat the heater. In turn the heater heats the liquid through the sidewalls of the through-channels 109a and 111a, as the liquid is drawn through the through-channels 109a and 111a, to create a vapour. The vapour then exits the second plurality of through-channels 111a as a vapour flow.

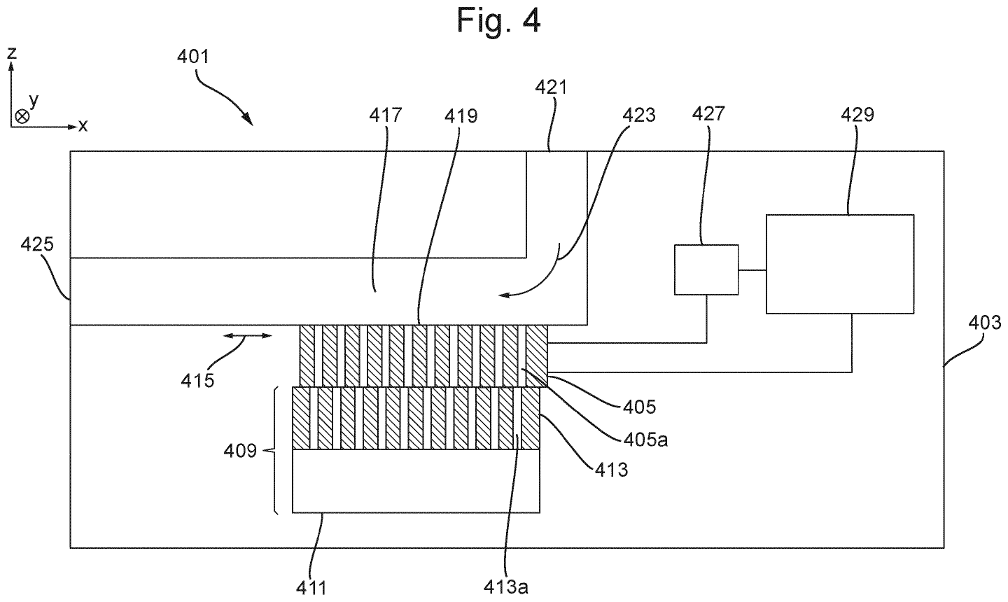

FIG. 4 shows an aerosol generating device 401 in accordance with the third aspect of the invention. The aerosol generating device 401 comprises a housing 403 configured to receive a consumable capsule 409, and a device evaporator body 405 housed within the housing 403. The aerosol generating device 401 further comprises an airflow channel 417 that extends through the aerosol generating device 401.

The device evaporator body 405 is arranged such that it comprises an outlet surface 419 that is exposed to the interior of the airflow channel 417. The consumable capsule 409 comprises a capsule evaporator body 413 and a reservoir 411 for storing a vaporisable liquid. The capsule evaporator body 413 is configured to receive a vaporisable liquid from a reservoir 411.

The capsule evaporator body 413 has a first plurality of through-channels 413a that extend through the capsule evaporator body 413. The first plurality of through-channels 413a extend parallel to one another along the z direction. In this example, the first plurality of through-channels 413a are regularly spaced from one another along the x direction. Each one of the first plurality of through-channels 413a is sufficiently narrow (i.e. has a sufficiently small cross-sectional area in the x-y plane) that when it receives the vaporisable liquid, the vaporisable liquid can travel along the first plurality of through-channels 413a by capillary action.

The device evaporator body 405 has a second plurality of through-channels 405a that extend through the device evaporator body 405. The device evaporator body 405 is disposed directly on the capsule evaporator body 413. The second plurality of through-channels 405a extend along the z direction, parallel to one another, through the device evaporator body 405. In use, the second plurality of through-channels 405a overlap with the first plurality of through-channels 413a to receive a vaporisable liquid from the first plurality of through-channels 405a. The vaporisable liquid is transported through the through-channels by capillary action to the outlet surface 419.

The device evaporator body 405 is moveable in the plane of the device evaporator body 405. This allows the degree of overlap of the first plurality of through-channels 413a and the second plurality of through-channels 405a to be adjusted. More specifically, the first plurality of through-channels 413a preferably have a corresponding first plurality of openings on the capsule evaporator body 413 and the second plurality of channels 405a have a corresponding second plurality of openings on the device evaporator body 405. Preferably the aerosol generating device 401 is configured such that movement of the capsule evaporator body 413 relative to the device evaporator body 405 changes the amount of overlap between the first plurality of openings and second plurality of openings to change the rate at which liquid flows through the aerosol generating device 401. For example, the device evaporator body 405 can be continually advanced and retracted along the x direction as indicated by the arrow 415, such that the degree of overlap of the first plurality of through-channels 413a with the second plurality of through-channels 405a is adjusted. Changing the degree of overlap of the first plurality of through-channels 413a with the second plurality of through-channels 405a affects the rate at which the vaporisable liquid travels through the through-channels by capillary action. Accordingly, adjustably moving the device evaporator body 405 relative to the consumable capsule 409 when received in the housing can be used to vary the rate at which the vaporisable liquid is transported through the through-channels. This in turn can affect the size of the droplets in the generated vapour and the overall rate at which the vapour is produced.

The aerosol generating device 401 comprises a heater that is arranged to supply heat to the vaporisable liquid as it passes through the through-channels. In this example, heaters are provided within the device evaporator body 405 and capsule evaporator body 413. More particularly, the device and/or capsule evaporator bodies comprise an electrically conductive material and a current is passed through the first and second bodies to heat them using resistive heating.

For example, the device evaporator body 405 may be connected to an electronic control circuit 427. The electronic control circuit 427 is configured to apply a voltage across the device evaporator body 405, which can be controlled by the electronic control circuit 427 so as to heat the device evaporator body 405 by resistive heating. The voltage applied by the electronic control circuit 427 can also be controlled so as to influence parameters such as the contact angle between the vapourisable liquid and the interior of the second plurality of through-channels 405a, which in turn affect the rate at which the liquid is transported to the outlet surface 419 and the properties of the generated vapour. For example, when the device evaporator body 405 is heated, the temperature of the liquid inside the second plurality of through-channels 405a increases. This typically increases the rate at which the vapour is generated.

Similarly, the capsule evaporator body 413 may be connected to a second electronic control circuit (not shown). Like the electronic control circuit 427, the second control circuit is configured to vary the voltage across the capsule evaporator body 413 so as to control the temperature of the capsule evaporator body 413 and parameters such as the contact angle between the vapourisable liquid and the first plurality of through-channels 413a. It is preferable that the device evaporator body 405 is kept at a higher temperature than the capsule evaporator body 413 when the capsule evaporator body 413 and/or device evaporator body 405 is heated. Hence, in this embodiment, each of the device evaporator body 405 and the capsule evaporator body 413 is a micro-electromechanical system (MEMS) that affords control over the rate at which the vapourisable liquid is transported to the outlet surface 419 and the properties of the generated vapour.

Although in this embodiment the device evaporator body 405 is provided with an electronic control circuit 427, two control circuits could be configured to control both bodies in other embodiments.

In an alternative embodiment, a first external heater (not shown) may be arranged to supply heat to the device evaporator body 405. The first external heater can be electrically powered (for example by a battery of an aerosol generating device) and controlled by an electronic controller. When the device evaporator body 405 is heated, the temperature of the liquid inside the second plurality of through-channels 405a increases. This typically increases the rate at which the vapour is generated. Similarly, the capsule evaporator body 413 may be provided with a second external heater (not shown), which may also be electrically powered and controlled by an electronic controller.

In this embodiment the device evaporator body 405 is provided with a first external heater. However, the capsule evaporator body 413 could instead be provided with an external heater or both the device evaporator body 405 and the capsule evaporator body 413 could be provided with a respective heater. In other embodiments, both the device evaporator body 405 and capsule evaporator body 413 could be heated by a single heater. In embodiments where the device evaporator body 405 is heated (whether the capsule evaporator body 413 is heated or otherwise), it is preferable that the device evaporator body 405 is kept at a higher temperature than the capsule evaporator body 413 when the aerosol generating device 401 is in use.

In this embodiment, the first external heater is external to the device evaporator body 405 and the first external heater is configured to heat the device evaporator body 405 by conductive heating. The device evaporator body 405 comprises a heat conductive material such as metal or a ceramic such that the heat provided by the heaters 407 is passed through the device evaporator body 405.

Although the device and capsule evaporator bodies 405, 413 may be heated by external heaters, it is preferred that the device and capsule evaporator bodies 405, 413 comprise an electrically conductive material and a current is passed through the device and capsule evaporator bodies to instead heat them using resistive heating.

Air can be drawn into the airflow channel 417 through an inlet 421 and travel through the airflow channel along the direction indicated by the arrow 423. As the air passes the outlet surface 419 of the device evaporator body, droplets of the vaporisable liquid are drawn away from the outlet surface 419 by the airflow. This produces a vapour of the vaporisable liquid. The vapour continues to travel along the airflow channel 419 and exits the aerosol generating device 401 via an outlet 425. The outlet could be provided with a mouthpiece (not shown), allowing the airflow to be generated by a user drawing on the device 401 at the mouthpiece.

In this example, the device evaporator 405 is in communication with an electronic controller 427. The electronic controller 427 can be configured to control components of the evaporator assembly including the heater. The electronic controller 427 can also be configured to control other components of the aerosol generating device 401. The aerosol generating device 401 also has a power source 429, for example a rechargeable battery. The power source is configured to supply power to the components of the device plate 405 and the electronic controller 427, and can also power other components of the aerosol generating device 401, for example any valves and reheaters that may be present in the airflow channel or any lights for displaying information about the operation of the aerosol generating device 401.

In the example of FIG. 4, the reservoir 411 and the capsule evaporator body 413 are provided as a removable capsule 409. In particular, the capsule 409 is received in the device such that the capsule evaporator body interfaces with the device evaporator body 405 to provide the fluid communication between the reservoir 411. The device evaporator body 405 is then moveable to provide the selected degree of registration between the first plurality of through-channels 405a and the second plurality of through channels 413a.

However in other examples, the components provided as a removable capsule may differ. For example, all components of the evaporator may be provided as a removable capsule or the evaporator may be integral within the aerosol generating device 401 and the capsule may comprise the reservoir.

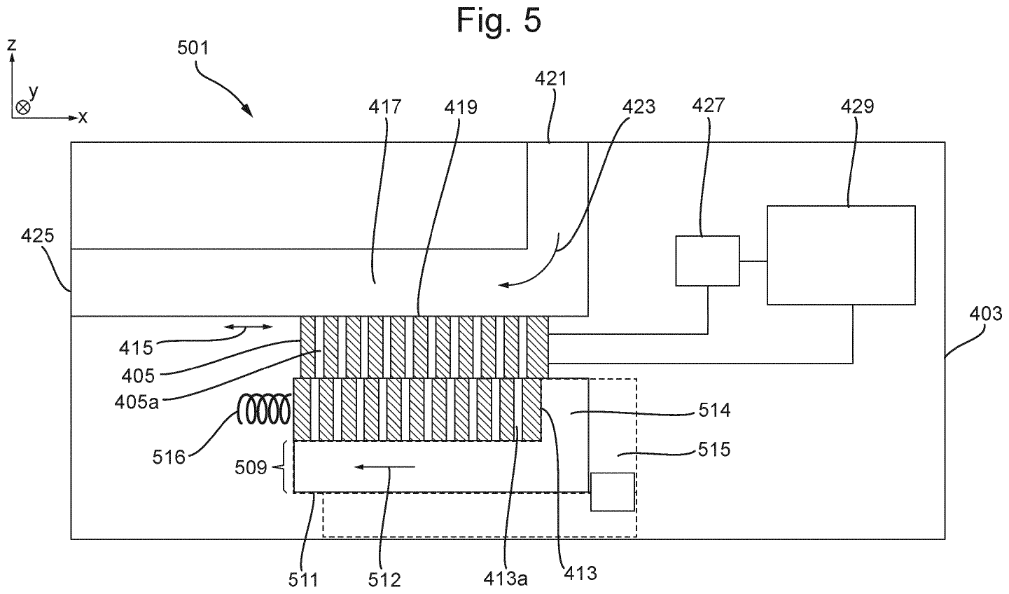

FIG. 5 illustrates an alternative embodiment in which all components of FIG. 4 are still present other than the following differences. In this example the entire evaporator assembly comprising the second body 405 and first body 413 are integral within the aerosol generating device 501. The removable capsule 509 comprises a liquid reservoir 511 and is received within the aerosol generating device so that it interfaces with the second and first evaporator bodies 405, 413 to provide fluid communication between the reservoir 511 and the first and second plurality of through channels 405a, 413a.

The example of FIG. 5 comprises a number of additional components. In particular, the capsule 509 is shaped such that when received within the aerosol generating device it moves the first body 413 to a predetermined position relative to the second evaporator body 405. The aerosol generating device comprises a cavity 515 for receiving the capsule 509, wherein the capsule and the cavity 515 are shaped such that the cartridge must be inserted in such a way, shown by arrow 512, as to provide a force on the first evaporator body 413 to move it into position. In this example the first body 413 is biased with a spring 516 and the capsule 509 comprises a protruding portion 514 which pushes against the first body 413 so as to move it against the biasing force of the spring so that the position of the capsule 509 when received defines the position of the first body 413. Again, the spring 516 may comprise a shape memory allow such that the biasing force is also determined by the temperature supplied by the heater. In this way, the alignment of the first and second plurality of through channels 405a, 413a is determined both by the capsule 509 inserted and the temperature provided by the heater. The aerosol generating device 501 may comprise a securing means such as a magnetic or mechanical connection which retains the capsule 509 in the received position illustrated in FIG. 5 and accordingly holds the first evaporator body 413 in the required position relative to the device evaporator body 405.

In this way the capsule 509 can be configured by providing an appropriate shape such that the evaporator is set at the correct position for the viscosity of liquid held in the reservoir 511 of the capsule 509. Capsules with different widths of the protruding portion 514 will move the first evaporator body 413 by different amounts, allowing the degree of registration between first and second plurality of through-channels 405a, 413a to be set for the liquid held in the capsule 509.

1. An evaporator assembly for an aerosol generating device comprising:
a first body having a first plurality of through-channels;
a second body having a second plurality of through-channels;
wherein the first body and the second body are arranged such that the first and second plurality of through-channels overlap to allow the passage of a liquid from an inlet end to an outlet end of the evaporator assembly through the through-channels; and
a heater arranged to heat the liquid as it passes through the through-channels;
wherein the second body is moveable with respect to the first body such that an area of overlap is adjustable.

2. The evaporator of claim 1, wherein the heater is configured to heat the liquid such that it evaporates as it passes through the through-channels.

3. The evaporator assembly according to claim 1, wherein at least one of the first body or the second body comprises the heater.

4. The evaporator assembly according to claim 3, wherein each of the first body and the second body comprises the heater.

5. The evaporator of claim 1, wherein at least one of the first body and second body are heatable by resistive heating.

6. The evaporator of claim 5, wherein at least one of the first and second body comprise an electrically conductive material and the evaporator assembly further comprises circuitry for passing a current through the electrically conductive material to heat at least one of the first body and second body by resistive heating.

7. The evaporator assembly according to claim 1, wherein the evaporator is arranged such that liquid is transported along the through-channels by capillary action.

8. The evaporator assembly according to claim 1, wherein the first body comprises an outlet surface wherein the first plurality of through-channels run through the first body to a first plurality of openings on the outlet surface; and
the second body comprises an inlet surface wherein the second plurality of through-channels run through the second body from a second plurality of openings on the inlet surface;
wherein the outlet surface and inlet surface are in contact and arranged parallel to each other so that the first plurality of openings overlap with the second plurality of openings.

9. The evaporator assembly according to claim 1, wherein the second body can be translated laterally with respect to the first body to adjust the area of overlap.

10. The evaporator assembly according to claim 1, wherein the second body can be rotated with respect to the first body to adjust the area of overlap.

11. The evaporator assembly according to claim 1, wherein at least one of the first body or second body is spring loaded.

12. The evaporator assembly according to claim 1, further comprising a stepper motor, wherein the stepper motor is coupled to the second body and is configured to provide the movement between the first body and second body.

13. The evaporator assembly according to claim 1, further comprising a rotary encoder arranged to measure the relative position between the first body and the second body.

14. The evaporator assembly according to claim 1, further comprising a strain gauge arranged to measure the relative position between the first body and the second body.

15. The evaporator assembly according to claim 1, further comprising: a reservoir for storing the liquid; wherein the reservoir is fluidically coupled to the first body.

16. An aerosol generating device comprising:
the evaporator assembly according to claim 1;
a power source arranged to supply power to the evaporator assembly; and
a reservoir for storing the liquid;
wherein the reservoir is fluidically coupled to the first body.

17. The aerosol generating device according to claim 16, wherein the reservoir is removable from the aerosol generating device.

18. An aerosol generating device comprising:
a housing, configured to receive a consumable capsule comprising a reservoir for storing a liquid and a capsule evaporator body having a first plurality of through-channels;
a device evaporator body within the housing, the device evaporator body comprising a second plurality of through-channels; and
a heater arranged to heat the liquid as it passes through the through-channels;
wherein the first plurality of through-channels and the second plurality of through-channels overlap to allow a liquid to pass through the first and second plurality of through-channels; and
wherein the device evaporator body is moveable relative to the consumable capsule when received in the housing such that an area of overlap between the first plurality of through-channels and second plurality of through channels is adjustable.
